(19) United States
(12) Patent Application Publication
(10) Pub. No.: US 2003/0040887 A1
(43) Pub. Date: Feb. 27, 2003

(54) System and process for constructing and analyzing profiles for an application

(76) Inventors: Eric A. Shupps, Roanoke, TX (US); Kirk H. Wilson, Dallas, TX (US); Jonathan Swartz, Dallas, TX (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/161,845

(22) Filed: Jun. 4, 2002

Related U.S. Application Data
(60) Provisional application No. 60/295,646, filed on Jun. 4, 2001.

(51) Int. Cl. G06F 15/00

(52) U.S. Cl. 702/187

(57) ABSTRACT

A process can generate prospective information regarding application. In one example, rendered source code for the application could be received by a client computer from a server computer. The process can comprise retrieving data regarding historical information for the application and generating prospective information regarding the application based at least in part on the historical information. Examples of prospective information can comprise scenario modeling, predictive analysis, forecasting, scalability estimation, combinations thereof, derivations thereof, or the like. In many embodiments, the process can further comprise parsing the application to identify components within the application. At least some of the components can be part, but not all, of a document. The process can still further comprise testing the components to generate the historical information for the components. The profile construction and analysis may be performed for a group of applications.

### TECHNICAL FIELD OF THE INVENTION

This invention relates in general to analyzing application(s), and more particularly, to constructing and analyzing a profile for application(s) to determine its (their) functionality and performance.

### DESCRIPTION OF RELATED ART

Currently, software programs exist for analyzing historical data for an application (e.g., a web site accessible via the Internet), where rendered source code for the application is transmitted over a network to a client computer. Typically, the analysis performed by the software program is entirely historical. In many instances, the historical data is used to identify a cause of a problem that currently exists. The analysis is problematic because it is reactive, as opposed to proactive. Further, its ability to analyze the historical data is limited to data at levels no lower than a document level. The lack of granularity of data effectively prevents any in-depth analysis of the application. Also, such a limited, high-level analysis may not reveal problems or other conditions not seen at the document level or higher.

### SUMMARY OF THE INVENTION

A system and process for generating prospective information regarding an application. The process can comprise retrieving data regarding historical information for the application and generating prospective information regarding the application based at least in part on the historical information.

In one specific embodiment, the application may be designed to be used on a network, although this is not a requirement. In still other embodiment, the analysis may be performed for a plurality of applications. Although not required, the process may further comprise identifying components within the application. At least some of the components can be part, but not all, of a document. The process may still further comprise testing the components to generate the historical information for the components.

By performing the analysis at a level lower than the document level, more accurate and useful information can be generated. Examples of prospective information can comprise scenario modeling, predictive analysis, forecasting, scalability estimation, combinations thereof, derivations thereof, or the like. Unlike conventional programs, the processes described herein can take a proactive approach, rather than solely a reactive approach. In a specific embodiment, the construction and analysis of a profile for a plurality of applications may be performed. In this manner, loads on hardware resources may be estimated to determine if change(s) to any one or more of the applications has a significant impact, and potentially, quantify the effect of the change.

Embodiments may include a data processing system readable medium having code embodied therein, which code is designed to generate prospective information for the application designed to be used on a network. The code of the data processing system readable medium can comprise instructions for carrying out the processes described.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes an illustration of a client computer and a server computer as part of a computer network.

FIG. 2 includes an illustration of a data processing system storage medium including software code having instructions in accordance with an embodiment described herein.

FIG. 3 includes a flow diagram for constructing and analyzing a profile in accordance with an embodiment described herein.

FIGS. 4-7 include flow diagrams for identifying components and relationships between components for rendered source code that is designed to be used on a computer network.

FIG. 8 includes a flow diagram of a detailed portion of constructing a profile.

FIG. 9 includes a flow diagram for identifying component patterns when constructing the profile.

FIG. 10 includes a flow diagram for identifying component relationship patterns when constructing the profile.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Reference is now made in detail to the exemplary embodiments of the invention, examples of which are illustrated in the accompanying drawings. Wherever possible, the same reference numbers will be used throughout the drawings to refer to the same or like parts (elements).

A few terms are defined or clarified to aid in understanding the descriptions that follow. A network includes an interconnected set of server and client computers over a publicly available medium (e.g., the Internet) or over an internal (company-owned) system. A user at a client computer may gain access to the network using a network access provider. An Internet Service Provider (“ISP”) is a common type of network access provider. A network address includes information that can be used by a server computer to locate information, whether internal to that server computer or at a different, remote computer or database. Uniform Resource Locators (“URLs”) are examples of network addresses.

A network site typically includes documents, network pages, files or other information displayed at different network addresses for that network site. A web site is a common type of network site, and a web page is a common type of network page. The network site may be accessible using a client-server hardware configuration. Documents may consist of the individual software program(s), code files, scripts, etc. An application typically includes a plurality of documents that are network pages, and a network domain may include a plurality of applications. Note that the examples given within this paragraph are for purposes of illustration and not limitation.

The system and process described herein is for constructing and processing profiled of an application, typically a web-enabled application. A “web-enabled” application is one that operates over HTTP (or similar) Internet protocol and can be accessed or manipulated using an Internet browser such as Netscape Navigator or Microsoft Internet Explorer. Web-enabled applications may include Internet applications, E-commerce based systems, extranets, and other similar types of applications that use network based technologies. The term “application” includes a web site and its constituent parts, including but not limited to, code, scripts, static and dynamic web pages, documents, and software programs, designed to reside on, and be accessed or utilized via a network such as the Internet. The term “application” also includes software programs and constituent parts (that may include source code, static documents (e.g., web pages), and calls to other programs or data.

For purposes of this invention “components” are subparts of an application; thus components include the individual parts that make up a document and may be links, form fields, images, applets, etc. Components can also refer to a set of related, lower level components. An order form is an example of a component that may include a set of other components, such as a name field, an address field, a payment field, an image of a product being ordered, etc. As can be seen by the example, the components within the order form have a child-parent relationship with the order form.

Components may be further separated into two types: transactable and non-transactable. Transactable components are those components upon which a user may act to produce a result. Examples of transactable components are hypertext links, scripts, image maps, forms, and applets. Non-transactable components, in contrast, are those for which no user input is required; an example of this may be a static, unmapped image.

The term “contextual relationship” is intended to mean a relationship within a single document. For example, an anchor tag, commonly known as a bookmark, which is a link on a page leading to another location in the same page, would exhibit a contextual relationship with the document in which it is located. The term “cross-contextual relationship” is intended to mean relationships extending outside a single document. A cross-contextual relationship may exist between two components on different network pages within the same domain or a link to a page or other component at a different domain.

common type of network site, and a web page is a common type of document. Note that the examples given within this paragraph are for purposes of illustration and not limitation.

As used herein, the terms “comprises,” “comprising,” “includes,” “including,” “has,” “having” or any other variation thereof, are intended to cover a non-exclusive inclusion. For example, a process, method, article, or apparatus that comprises a list of components is not necessarily limited only those components but may include other components not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

A process can be used to generate prospective information regarding an application. In one example, code for the application, which may be designed to be used on a network, can be rendered source code that could be received by a client computer from a server computer. The rendered source code may be in a scripting language capable of being processed by a browser on the client computer. The process can comprise retrieving data regarding historical information for the code and generating prospective information regarding the code based at least in part on the historical information. In many embodiments, the process can further comprise identifying components within the application. At least some of the components can be part, but not all, of a network page. In a specific non-limiting embodiment, the component may be a form, an image, an input field, or the like. The component can be a link but this is not required.

Although not required, the process may further comprise identifying components within the application. At least some of the components can be part, but not all, of a document. The process may still further comprise testing the components to generate the historical information for the components. The process can still further comprise testing the components to generate the historical information for the components.

By performing the analysis at a relatively low level (e.g., lower than the document level), more accurate and useful information can be generated. Examples of prospective information can comprise scenario modeling, predictive analysis, forecasting, scalability estimation, combinations thereof, derivations thereof, or the like. Unlike convention programs, the processes described herein can take a proactive approach, rather than solely a reactive approach.

The application may be designed to be used on a network, although this is not a requirement. In a specific embodiment, the construction and analysis of a profile for a plurality of applications may be performed. In this manner, loads on hardware resources may be estimated to determine if change(s) to any one or more of the applications has a significant impact, and potentially, quantify the effect of the change.

Before discussing embodiments of the invention, an exemplary hardware architecture for using embodiments is described. FIG. 1 illustrates an exemplary architecture and includes a client computer 12 that is bi-directionally coupled to a network 14 (e.g. the Internet) and database 18, and a server computer 16 that is bi-directionally coupled to the network 14. The client computer 12 includes a central processing unit (“CPU”) 120, a read-only memory (“ROM”) 122, a random access memory (“RAM”) 124, a hard drive (“HD”) or storage memory 126, and input/output device(s) (“I/O”) 128. The I/O devices 128 can include a keyboard, monitor, printer, electronic pointing device (e.g., mouse, trackball, etc.), or the like. The server computer 16 can include a CPU 160, ROM 162, RAM 164, HD 166, and I/O 168. The server computer 16 may have a cache memory that resides in RAM 164.

Each of the client computer 12 and the server computer 16 is an example of a data computer system. ROM 122 and 162, RAM 124 and 164, HD 126 and 166, and the database 18 include media that can be read by the CPU 120 or 160. Therefore, each of these types of memories includes a computer system readable medium. These memories may be internal or external to the computers 12 and 16.

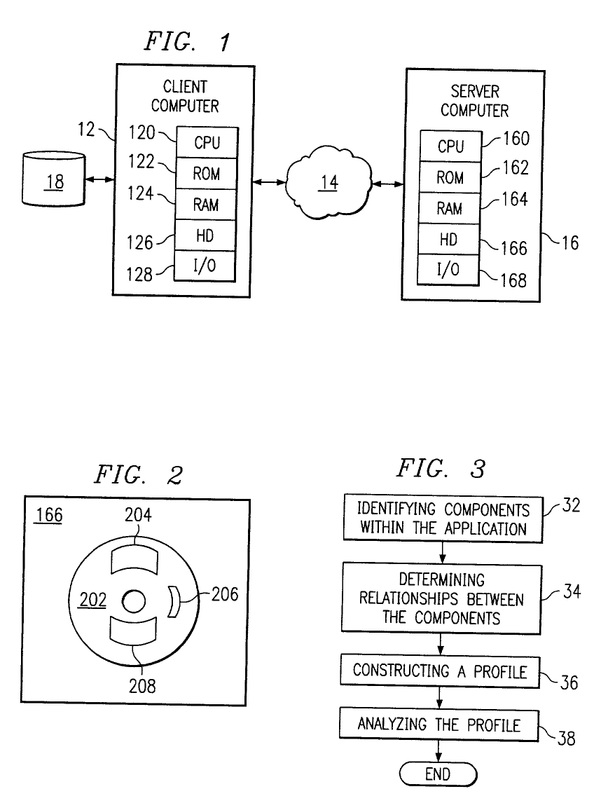

The processes described herein may be implemented in suitable software code that may reside within ROM 122 or 162, RAM 124 or 164, or HD 126 or 166. In addition to those types of memories, the instructions in an embodiment of the invention may be contained on a data storage device with a different data computer system readable storage medium, such as a floppy diskette. FIG. 2 illustrates a combination of software code components 204, 206, and 208 that are embodied within a computer system readable medium 202, on HD 126. Alternatively, the instructions may be stored as software code components on a DASD array, magnetic tape, floppy diskette, optical storage device, or other appropriate computer system readable medium or storage device.

In an illustrative embodiment of the invention, the computer-executable instructions may be lines of compiled C++, Java, HTML, or any other programming or scripting code. Other architectures may be used. For example, the functions of the client computer 12 may be incorporated into the server computer 16, and vice versa. Further, other client computers (not shown) or other server computers (not shown) similar to client computer 12 and server computer 16, respectively, may also be connected to the network 14. FIGS. 3-10 include illustrations, in the form of flowcharts, of some of the structures and operations of such software programs.

Communications between the client computer 12 and the server computer 16 can be accomplished using electronic, optical, radio frequency signals, or other methods of communication. When a user is at the client computer 12, the client computer 12 may convert the signals to a human understandable form when sending a communication to the user and may convert input from a human to appropriate electronic, optical, radio frequency signals, etc. to be used by the client computer 12 or the server computer 16. Similarly, when an operator is at the server computer 16, the server computer 16 may convert the signals to a human understandable form when sending a communication to the user and may convert input from a human to appropriate electronic, optical, or radio frequency signals to be used by the server computer 16 or the client computer 12.

Attention is now directed to processes for generating prospective information regarding an application designed to be used on a network. Although not required, the application being profiled and analyzed may be rendered source code in a markup language to be rendered by a browser.

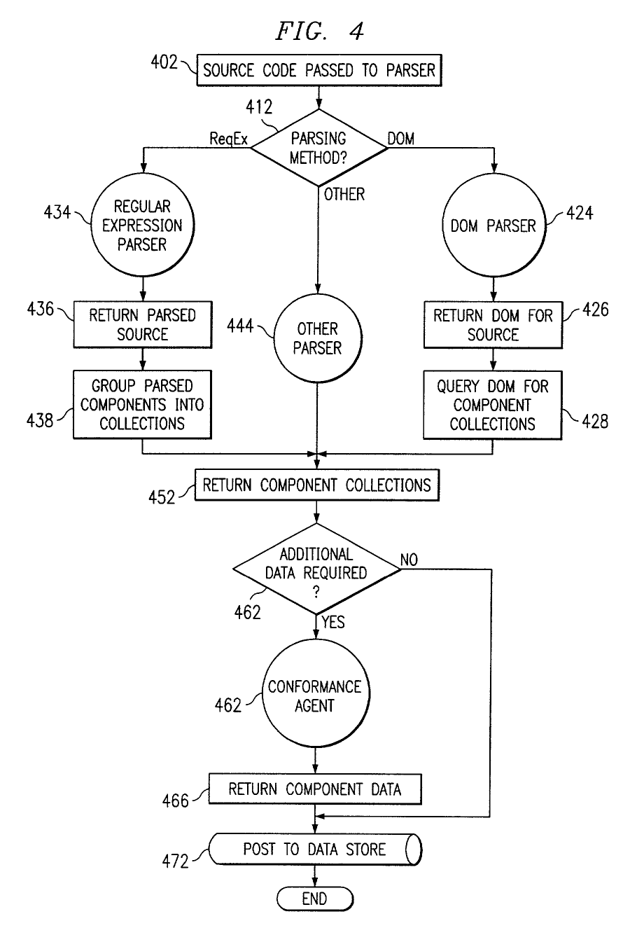

In one embodiment, the process of the present invention can comprise identifying components within the application (block 32) and determining relationships between the components (block 34) as shown in FIG. 3. The process can also comprise constructing a profile (block 36) and analyzing the profile (block 38). The identification of components and component relationships may be performed using the processes described and illustrated in FIGS. 4-7. The profile may be constructed from test data collected on the components and the component relationships. The profile may also include information related to metadata that describes how the test data was collected when the rendered source code was executed by a client browser. In many embodiments, the analysis of the profile may comprise generating prospective information including scenario modeling, predictive analysis, forecasting, scalability estimation, combinations thereof, derivations thereof, or the like.

As a non-limiting example, the process can be used for an application that includes software program(s) or code that operate a network site or a significant portion thereof, such as an Internet web site. The application, when presented by the server computer 16 can generate rendered code that may be transmitted over the network 14 to the client computer 12. The rendered code may be in a markup language including HyperText Markup Language (“HTML”) or any of the well known variants, eXtensible Markup Language (“XML”) or any of its variants, Wireless Markup Language (“WML”) or any of its variants, or any other current and future markup, scripting, or programming languages. A software program on the client computer 12, such as a browser, can use the rendered code to display information to the user at the client computer 12 via an I/O device 128.

Unlike most other methods of gathering data on Internet software applications, the rendered code may be, evaluated at the client computer 12 instead of assembling information from the original code at the server computer 16. Harvesting information at the client computer 12 can better reflect the experience and potential responses of actual users. Additionally, as the rendered code at the client computer may be entirely different from the original code, information gathered from the rendered code may uncover errors or other potential problems that would not be seen if data was obtained from the pre-execution code at the server computer 16.

Attention is now directed to details of identifying components (block 32 in FIG. 3) and determining relationships between the components (blocks 34 in FIG. 3) of the application.

Components may have parent-child relationships as previously described in the definition section. Components may be further separated into two types: transactable and non-transactable. Transactable components are those components upon which a user may act to produce a result. Examples of transactable components are hypertext links, scripts, image maps, forms, and applets. Non-transactable components, in contrast, are those for which no user input is required, an example of this may be a static, unmapped image.

After the rendered code is retrieved (block 310), the process can include parsing the code to identify components within the code as shown in FIG. 4. This process includes: choosing which type of parsing method is going to be utilized (diamond 412), returning the collection of components assembled from the parser (block 452), determining if additional data is required on any of the components discovered (diamond 462), and posting the results of the parsing to a data store (block 472).

As an example, consider the following rendered code. Bolded text and arrows below are notations for various components within the code, but are not part of the rendered code. The process will be performed to identify the components as noted.

<HTML>
<HEAD>
<TITLE>Search Page</TITLE>

<SCRIPT LANGUAGE=‘Javascript’

SRC=‘scripts/script.js’> ← SCRIPT COMPONENT

</SCRIPT>

<BODY>

<IMG SRC=‘images/image1.gif’> ← IMAGE COMPONENT

<BR>

<A HREF=‘http://www.anysite.com’>Click Here</A> ← LINK COMPONENT

<BR>

<FORM NAME=‘form1’ ACTION=“” METHOD=‘post’> ← FORM COMPONENT
<INPUT TYPE=‘text’ NAME=‘search’ SIZE=‘60’

VALUE=‘search text’ CLASS=‘input_text’>

<INPUT TYPE=‘submit’ NAME=‘action’ VALUE=‘Find’

CLASS=‘input_button’>

</FORM>

</BODY>
</HTML>

The code can be passed to a parser (block 402) and a determination is made regarding which parsing process will be used (diamond 412). The parsing may be performed using a regular expression parser (circle 434), a Document Object Model (DOM) parser (circle 424), or another type of parser (circle 444). As shown, the components are those portions of the application identified after the parsing process has been performed.

Regular expressions can be programmatic components that enable the complex manipulation, searching, and matching of textual components. The extensive pattern-matching notation of regular expressions allows an application to quickly parse large amounts of text to find specific character patterns; to extract, edit, replace, or delete text substrings; or to add the extracted strings to a collection in memory.

Regular expressions may be used to isolate components in documents, such as files coded in HTML or XML, by matching the pattern of content descriptors, known as “tags,” and text structures. For example, a regular expression that extracts hyperlinks from the code may resemble the following:

<A.*?href=[‘”]?([ˆ ’”\s>]+)[‘”]?[ˆ >]*?>(.*?)</A>

The result of executing the expression on the rendered code may include the following:

1. http://www.anysite.com

This example demonstrates the identification of an anchor component (the <A> and </A> tags) and the value associated with the component (the text between the tags that matches the structure defined in the expression). The same principle may be applied to any valid tags within the document language as well as free-form text that adheres to a fixed pattern or style. The parsed code can be returned (block 436), and the parsed components can be grouped into collections (block 438) where all the components match a certain regular expression associated with a type of component, for example a hypertext link, or the grouping may consist of one file or collection of all components discovered by the regular expression parser. The grouped component collection(s) can then be returned (block 452).

Attention is now directed to the DOM parser (circle 424). The DOM (part of the HTML 3.0 specification) can be a specification for how objects in a document are presented. The DOM can define what attributes are associated with each object, how the objects can be defined, and how the objects and attributes can be manipulated. The DOM may be used to identify page components by comparing the document structure to the data components specified in the DOM. In addition to exposing available components, the DOM may also contain the methods and properties available for each component and permit new object definitions, such as those found in XML documents, to be introduced without prior specification. Most, if not all, components which may comprise an application will be within the DOM.

Although the DOM is a standard World Wide Web Consortium (“W3C”) specification (incorporated fully herein by reference), each implementation of the DOM may be client specific. Under the W3C DOM, all components within an HTML web page will be within the DOM. The software program that presents the rendered code, such as a web browser, can maintain its own set of rules on how the rendering is to be performed and what the final document will look like. In order to ensure the likelihood that component identification is accurate, the system should be “client-aware,” that is access the rendered code that would be presented to a client computer 12, by using the network 14 and server computer 16, or by rendering the code before utilizing the DOM parser. The system should have the ability to encapsulate, access, invoke or otherwise communicate with the parser specific to each supported rendering code. This may be achieved programmatically through a standard communication protocol, an application programming interface, translation layer or other means.

FIG. 4 shows one embodiment of the process of identifying page components, along with their associated methods and properties, using the DOM to extract hypertext links from rendered code. With reference to FIG. 4,

(a) The rendered code can be passed to an object, application, or other programmatic element that contains the DOM parser (circle 424).

(b) The parser (circle 424) returns the DOM for the code (block 426).

(c) The process can be used to query the DOM for a list of hyperlink components and related information or potentially other components (block 428).

(d) A collection of components along with their methods and properties can be returned (block 452). Again, this may be a collection based upon type of component, or an overall grouping of all components discovered.

Another parser other than the regular expression or DOM parsers may be used to identify components in code (see circle 444). Such means can include byte code parsing, character recognition, Boolean expressions, any other type of lexical or semantic analysis, or any other types of parsers which may or may not be currently known. Each process has inherent advantages and disadvantages; however, if the end result is similar to a collection of components, with or without methods and properties, the present invention may utilize this parser successfully as well. Just like the other parsers, component collections can then be returned (block 452).

Referring again to FIG. 4, after the code is parsed, a determination is made whether additional data is required (diamond 462). Identified components may have associated data values, in addition to their methods and properties, which require extraction from the code, including property values, actions, state information, unique identifiers, components, content, associated scripts, and other information. A conformance agent (circle 462) may be used to extract these values in a similar fashion to component identification, via regular expressions, the DOM, a combination of both, or an entirely different process. This additional component data can be returned (block 466) and posted in a data store (block 472). If additional data is not needed or desired (“No” branch of diamond 462), the component collections from block 452 can be posted to a data store (block 472).

In one example of gathering additional component data using the DOM, a valid statement for accessing a hyperlink component might resemble “window.document.anchors(0).” The resulting value of the HREF property of the anchor object can resemble “http://www.anysite.com.”

In contrast, a form, script, or applet may have multiple data components, such as fields, functions, or parameters. For example, a DOM query to retrieve the value of the search field might resemble the following instruction.

window.document.forms.item(“Form 1”).components.item (“search”).value

The resulting value of the “search” element may resemble “search text.”

In addition to identifying components and their associated methods, properties, and data values, thorough analysis can also include information on the relationships between components and their context. The component-specific data, such as functional and performance data, can be further evaluated, arranged, viewed, tested, processed and presented. In particular, testing of the components of the application can provide enhanced test results as compared to prior solutions.

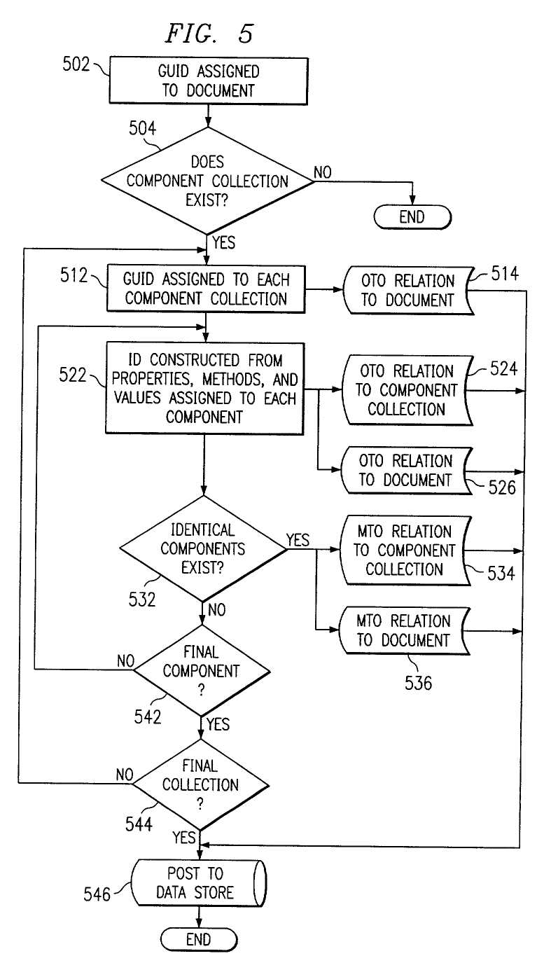

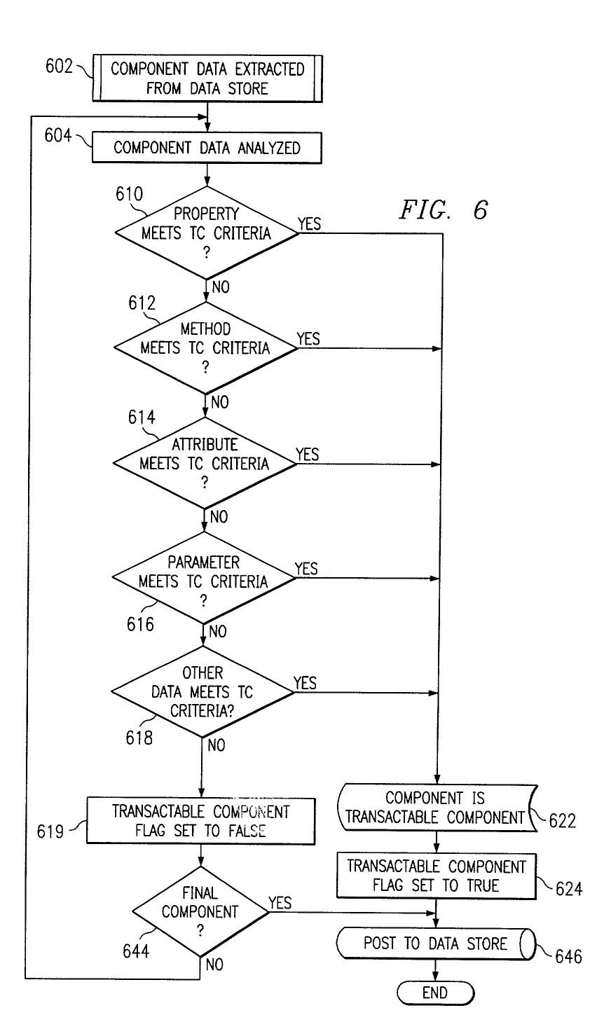

At this point, the process can be used for determining the relationships between the components as shown in FIGS. 5-7 and to be described in more detail below. Two types of relationships can be noted as contextual relationships and cross-contextual relationships.

A parent-child relationship may be defined wherein the component exists as a child, or sub-component, of the “container” in which it resides, such as a document, a network page, or the like (collectively referred to in FIGS. 5-7 as a “document”); the document is the parent while the component is the child. Similarly, methods, properties and data values may exist as sub-components of the component itself, such as the fields in a form and the values in each field. This creates a hierarchical model that accurately represents the nature of the components and their context.

FIG. 5 shows one embodiment of a process for determining contextual relationships among the identified components. The contextual relationship identification process can include assigning a Globally Unique IDentifier (“GUID”) to the document (block 502). The process can further include determining whether a component collection (which can comprise a single component) exists which corresponds to that document (diamond 504). If not, there are no children (i.e., sub-components) and the contextual relationship identification process ends. Otherwise, the process continues.

If at least one component collection exists, each component collection is assigned a GUID (block 512). A one-to-one (“OTO”) relationship between the component collection and the document from which the component collection came is then made (block 514). For each component within each component collection, an identifier can be constructed from the properties, methods, and values assigned to that component (block 522). This identifier can be created programmatically, for example using a checksum or CRC, or by using a DOM string or relative index, or by any other method which uniquely identifies each component. An OTO relationship between the component and its corresponding component collection can be made (block 524) and an OTO relationship between the component and the document can be made (block 526).

A determination may be made whether identical components exist (diamond 532). If identical components are discovered, a many-to-one (“MTO”) relationship between the component and each of the component collection (block 534) and document in which that component exists (block 536) are made.

The process can be iterated for all components within a component collection (diamond 542), and for all component collections corresponding to a document (diamond 544). Data regarding the contextual relationships can be posted to the data store (block 546).

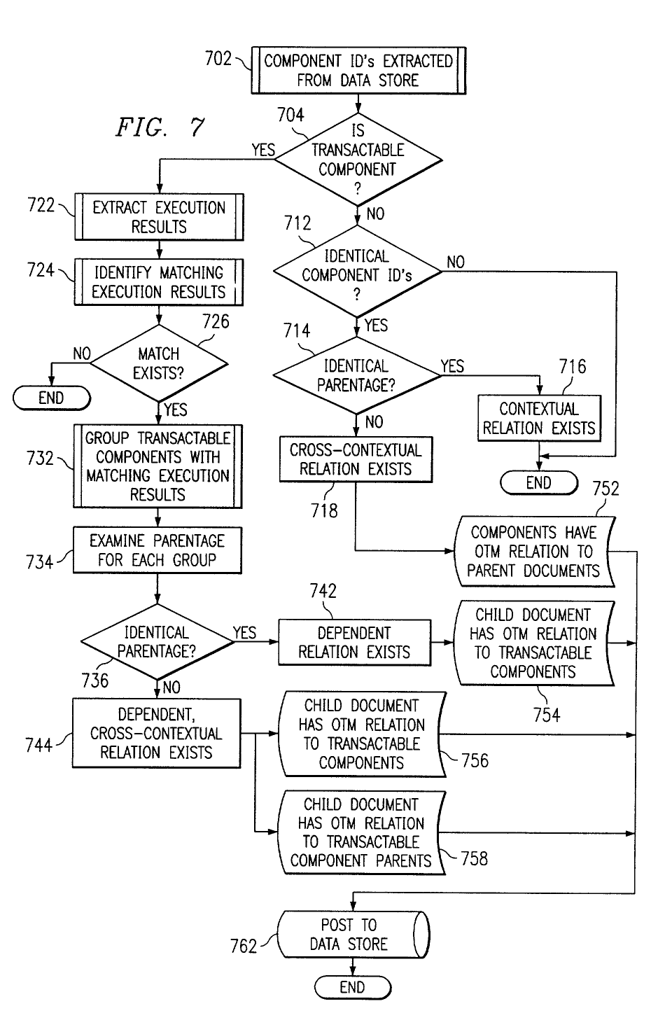

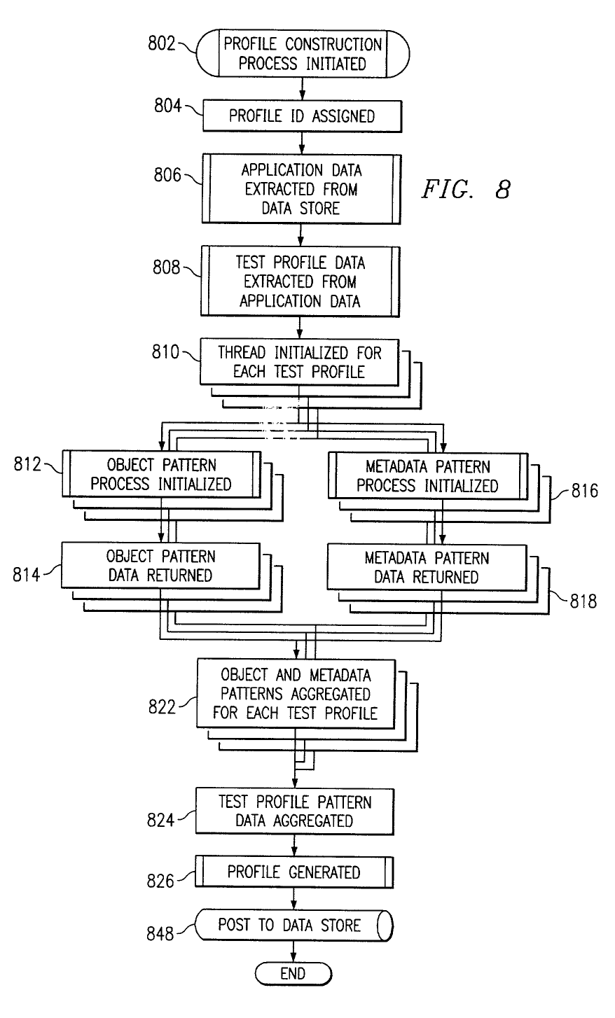

The component contextual relationship identification process may be further extended to include relationships between components in different contexts (defined herein as “cross-contextual relationships”), such as a form whose action property, when executed using input from the client computer 12, results in a new document being retrieved. The process can create a hybrid model that represents both hierarchical and dependent relationships. One embodiment of a process for determining cross contextual relationships between components will be described further herein (see FIG. 7).

In addition to identifying components of a document or set of documents in an application, the system and method can further isolate transactable components from non-transactable components. FIG. 6 depicts one embodiment of the invention in which transactable components (TCs) can be identified by analyzing the properties, methods, attributes, parameters, and other component data. Hyperlinks, which lead the user to a destination or submit a specifically formatted request to a host, and forms, which collect data and submit it for processing, are both examples of transactable components. The system may be aware of what types of components are considered TCs, either by explicit definition or by analyzing the component properties, and may identify them as such upon discovery. A system may invoke a function and pass the component data directly or the function may extract the component data from the data store (block 602). After the component data is retrieved, the component data is analyzed (block 604). Each piece of component data is compared to established criteria associated with transactable components. These criteria may be related to the properties (diamond 610), methods (diamond 612), attributes (diamond 614), parameters (diamond 616), or other data (diamond 618) associated with a component. If any of the criteria is met (the “Yes” branches of the diamonds 610-618), component is a TC (block 622), and the transactable component tag for the component can be set to “True” (block 624). If none of the criteria is met (all “No” branches), the process can be used to set the flag to “False” (block 619). The process is iterated for the rest of the components remaining in the data store (diamond 644). Before ending this operation, the component information related to TCs can be posted to the data store (block 646).

Transactable components, like any other component, may be used repeatedly within a document. For purposes of properly identifying the relationships between the components of an application, especially in cases where a data set is associated with the component (as can be the case with forms and applets), each component should be uniquely identified in such a manner that, if the component is found in several locations, the system recognizes that a previously identified component is recurring and does not catalog a new component in the data store.

In one embodiment, after TCs have been identified and information regarding the TCs has been collected and stored, information regarding cross-contextual relationships among the components (including the TCs) may be generated as shown in FIG. 7. It should be understood that the process of identifying component relationships, both contextual and cross contextual, can be performed independently of isolating transactable components from non-transactable components. In the FIG. 7 embodiment, component identifiers can be extracted from the data store (block 702). A determination is made whether the component is a TC (diamond 704). If not, a determination is made whether another identical component identifier exists (diamond 712). If so (“No” branch from diamond 712), this portion of the process of FIG. 7 ends. Otherwise (“Yes” branch from diamond 712), a determination is made whether the identical components have identical parentage (diamond 714). If so (“Yes” branch of diamond 714), a contextual relationship exists (block 716). Otherwise (“No” branch of diamond 714), a cross-contextual relationship exists (block 718), and the identical components without identical parentage are noted as having a one-to-many (“OTM”) relationship to the parent documents (block 752).

If the component is a TC (“Yes” branch of diamond 704), execution results from the component are extracted (block 722), and components having matched execution results are identified (block 724). For example, two links in a document return the identical page when executed. If a match between the execution results does not exist (“No” branch of diamond 726), this portion of the process is ended. Otherwise (“Yes” branch of diamond 726), TCs can be grouped with according to their corresponding matching execution results (block 732).

Each grouping of TCs can be examined for its parentage (block 734). A determination can be made whether groups have identical parentage (diamond 736). If so (“Yes” branch of diamond 736), a dependent relationship exists (block 742), and a notation can be made that the child document has an OTM relationship to the TCs (block 754). Otherwise (“No” branch of diamond 736), dependent, cross-contextual relationships exist (block 744), and notations can be made that the child document has an OTM relationship to the TCs (block 756) and an OTM relationship to the TC parents (block 758). The notations from blocks 752-758 and the resulting dependency map can be posted in the data store (block 762). The process can be repeated for the rest of the TCs within the document, network page, or other container.

The unique identifiers used in relationship definitions may be based on such factors as component type, name, and number of fields, field types, field values, action, and so forth. These factors may be used to construct a value, derived from the computation of a component-specific algorithm, which may be represented as a checksum, numeric/alphanumeric value, or other means, to identify a one-to-one or one-to-many contextual relationship. This value can then be used to uniquely identify the object and associate it with any data values or related components.

Cross-contextual relationships may be defined by matching the value of a component with values that exist outside of the component's individual context as previously described. In some instances a many-to-one, cross-contextual relationship may exist if the same component exists in multiple contexts. In others, a one-to-one, cross-contextual relationship may be defined if the child of one parent can be directly related to a different parent component when an action, such as a form post or hyperlink, is executed. These instances are known as dependent relationships; the relationship is not explicitly defined (such as in a parent-child relationship) but rather inferred by the property, method, or action of a component.

The process can further comprise testing the components to determine their statuses and various statistics. Statuses may include pass (green), warn (yellow), fail (red), or potentially other states. Pass or fail may be used depending on whether the code for the component has any errors. Warn may be used if the component has no errors, but a sub-component (child component) has an error. Statistics collected may be nearly limitless. Some examples may include component size, load time, number of errors, or the like. After reading this specification, skilled artisans appreciate that other statuses, statistics, and potentially other information may be collected during testing.

At this point, components and component relationships have been identified. Referring to FIG. 3, the process can further comprise constructing a profile (block 36). The profile typically includes test data related to the components and the component relationships. The profile may also include information related to metadata that describes how the test data was collected when the rendered source code was executed by a browser on the client computer 12.

Profile construction can be based upon the analysis of historical data relating to individual application components, their relationships and their use in transactional processes. Attempting to construct behavioral patterns only at a document level or higher is quite difficult because the documents are comprised of too many individual components and change too often to provide accurate change points over a specified interval. However, the process can be feasible when the emphasis is placed upon the action=result data derived from individual document components and the parent documents in which they are contained.

A pattern of change in individual documents, component classes, and child components, along with relationship vectors and transactional processes over time may provide adequate data from which to extrapolate a behavioral pattern for each object type. When aggregated across an entire network site, these isolated patterns can form an overall pattern for the application. Object pattern identification can be performed to identify document patterns, component patterns, and relationship patterns.

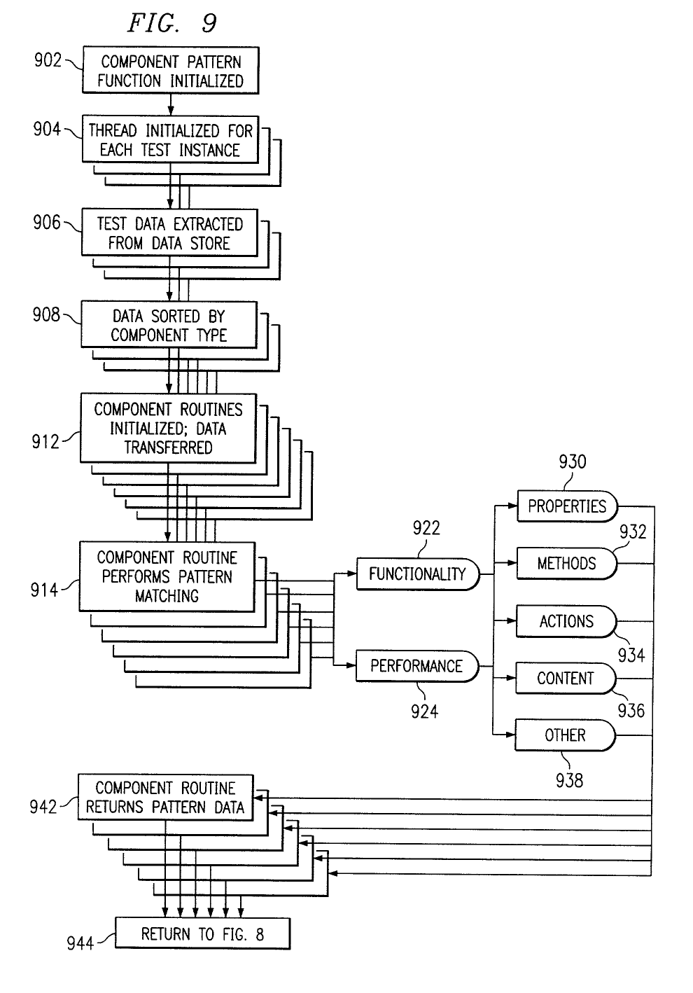

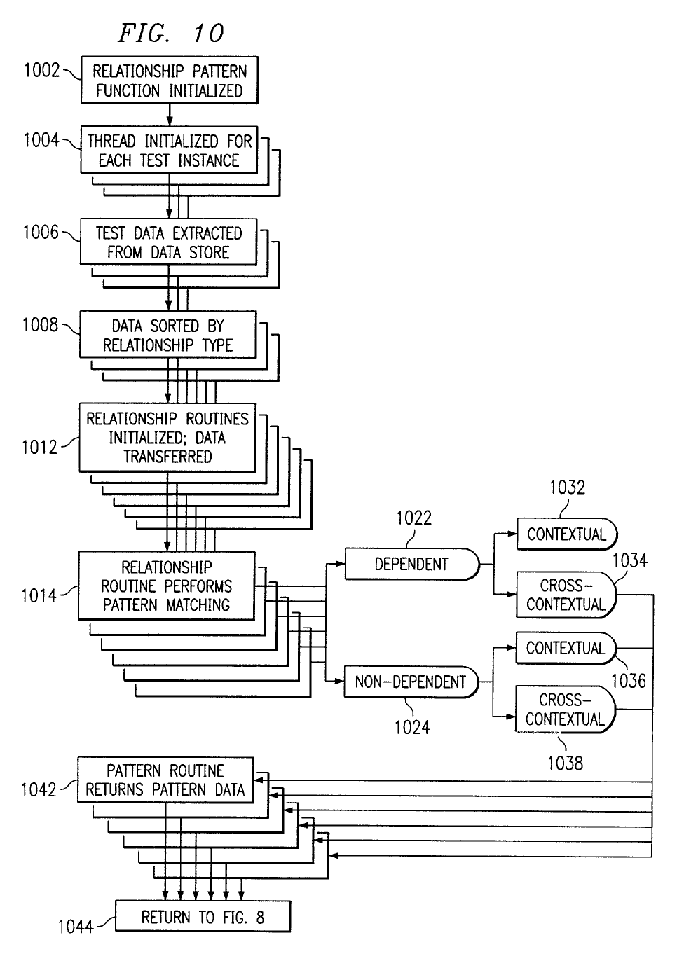

FIG. 8 includes a flow diagram that can be used to construct a profile that may be used for object and metadata pattern identification. The process can comprise initiating a profile construction process (block 802) and assigning a profile identifier (block 804). Application data can be extracted from the data store (block 806).

The process can further comprise extracting test profile data from the application data (block 808). For each application, multiple test profiles, which establish the test criteria, may exist. Within each test profile, each test instance that has been performed on the target application may result in relational data on the content, structure and layout of the target application, producing varying data sets. Extraction of the data related to individual profiles may require the initialization of a thread for each profile (block 810).

Attention is first directed to initiating processes for object pattern recognition (block 812) and returning the object pattern data (block 814). Object pattern identification can be performed to identify document patterns, component patterns, and relationship patterns.

Regarding documents, tracking the differences in document properties, content, performance and functionality from instance to instance can result in a change pattern for that document. Aggregating individual change points may provide the basis for forming a behavioral pattern for a document type. This information may be aggregated for the type of document to form a class pattern, which is an example of object pattern data that may be returned and posted to the data store.

In one embodiment, the process of defining document patterns can comprise a programmatic function, invoked by a system in accordance with a defined schedule or in response to a system event, which extracts document data from the data store, passes it to a routine which performs analysis functions to return one or more patterns.

Regarding component patterns, tracking the differences in individual component properties, methods, actions, content, performance and functionality from instance to instance can result in a change pattern for that component. Aggregating individual change points may provide the basis for forming a behavioral pattern for a component type. This information may be aggregated for the type of component to form a class pattern, which is another example of object pattern data that may be returned and posted to the data store.

In one embodiment, the process of defining component patterns may comprise a programmatic function, invoked by a system in accordance with a defined schedule or in response to a system event, which can extract component data from the data store and passes it to one or more routines based on the component (image, link, script, form, applet, etc.) and data type (functional, performance, etc.). Each routine can perform analysis functions to produce one or more patterns for the component or data type and returns the pattern information.

FIG. 9 includes a detailed flow diagram of one embodiment for component pattern recognition. A component pattern function can be initialized (block 902). A thread may be initialized for each test instance of the profile (block 904). Test data can be extracted from the data store (block 906) and sorted by component type (block 908). Component routines can be initialized, transfer data (block 912), and perform pattern matching (block 914). After pattern matching, functionality 922 (that may include pass/fail information) and performance 924 (that may include alert or warning information) can be determined by examining the properties 930, methods 932, actions 934, content 936, and potentially other information 938 for each component during each test. Note that some of the items 930-938 may not be examined. For example, for a static document, methods (932) and actions (936) may not be examined. After analyzing all the information, the component routine can return pattern data for the components (block 942). As shown in block 944, the process can continue at block 822 in FIG. 8 and will be described later.

Information about the relationships between documents and components, how they change from instance to instance, and what effect they have on the overall structure of an application, may result in relationship patterns. Identification of such patterns may require a relational tracking process that produces granular vectors on the relational changes in individual components, component classes, and the documents themselves.

In one embodiment, the process of defining relationship vectors can comprise a programmatic function, invoked by the system in accordance with a defined schedule or in response to a system event, which may extract relationship data from the data store, pass it to a routine that performs analysis functions to return one or more vectors as pattern information that can be posted to the data store.

FIG. 10 includes a detailed flow diagram of one embodiment for relationship pattern recognition. The first part of the process is similar to the process described with respect to FIG. 9. A relationship pattern function can be initialized (block 1002). A thread may be initialized for each test instance of the same test (block 1004). Test data can be extracted from the data store (block 1006) and sorted by relationship type (block 1008). Relationship routines can be initialized and transfer data (block 1012) and perform pattern matching (block 1014). After pattern matching, dependent relationships 1022 and non-dependent relationships 1024 can be examined. Within each of those relationships, contextual relationships 1032 and 1036 and cross-contextual relationships 1034 and 1038 can be examined. After analyzing all this information, the relationship routine can return pattern data for the relationships (block 1042). As shown in block 1044, the process can continue at block 822 in FIG. 8.

Returning to FIG. 8, attention is now directed to the metadata path that includes initializing a metadata pattern process (block 816) and returning metadata pattern data (block 818). Object patterns may have dependencies upon the processes used to collect the information on which the pattern is based. Documents, for example, may have different underlying data depending upon the application used to parse and render them. By extension, this can lead to pattern deviations for the same document set between different rendering applications. Such instances should have the identification of patterns within the metadata that describes how the original object data was collected.

In one embodiment, the process of defining metadata patterns can comprise a programmatic function, invoked by a system in accordance with a defined schedule or in response to a system event, which extracts metadata from the data store, passes it to a routine which performs analysis functions to return one or more patterns that can be posted to the data store.

After object and metadata pattern data have been returned, the resultant data may be aggregated across a defined period of time to produce an application profile for that period. More specifically, the process can comprise aggregating the object and patterns for each test profile (block 822) and aggregating test profile pattern data (block 824). The resultant data may be aggregated across a defined period of time to construct an application profile for that period (block 826). The profile can be posted to the data store (block 828). In addition, multiple profiles may be consolidated to produce an overall profile that encompasses multiple applications.

Now that a profile has been constructed, the process can continue with analyzing the profile (block 38 in FIG. 3). The analysis can be beneficial when generating prospective information regarding the application, components, or even a group of applications at a network site. Such prospective information can include scenario modeling, predictive analysis, forecasting, scalability estimation, combinations thereof, derivations thereof, or the like. The analysis can be performed from the user's perspective (as a client computer 12 accessing information from server computer 16 over the network 14.

Behavioral profiles may be used to construct “what if” scenarios based on variables, including any one or more of application changes, infrastructure enhancements, new feature additions and system modifications. Before taking any potential action, a user may develop a scenario by providing a system with data from which to construct a model that represents possible application functionality and performance based on the given parameters. This information may assist the user in making decisions about potential changes.

In one embodiment, the user may be contemplating adding a rich media component as a header for each application document. The user can develop a performance scenario with a goal of determining application performance if such a component were added to each document. By providing the system with size and load time of the component, and selecting which other components would be added or removed in conjunction, the system may construct a new application map or other representation by calculating the effect of the change on the behavioral patterns of the documents and components that comprise the target application. A visual display of the performance can result if the new component were added to each document. The user can review the information to determine whether the rich media component should be added.

Predictive analysis can combine the information contained in the profiles previously described with external data (external to the application or rendered source code) to produce a quantitative output in response to a query. External data may be supplied by the user, collected from other systems, or extracted from a data store as part of a manual or automated process. The query, in response to which the system performs one or more analysis functions, may also be supplied by the user, collected from other systems, or extracted from a data store as part of a manual or automated process.

In one embodiment, the user may be contemplating the purchase of new, more stable application server software and wishes to quantify the financial impact of application errors that occur in a set of defined transactions, both in terms of resource cost to fix identified errors and lost revenue. The user may provide the system with selected information. The selected information may include mean time to repair for each error type, resource cost, abandonment threshold by error type (the number of errors of a specific type that the user will tolerate before abandoning a transaction), the average revenue per transaction, the approximate reduction in error count resulting from the proposed software, the total implementation cost of the proposed software, combinations thereof, or the like. The system can use this information to perform analysis on trends derived from the profile for the application. The system can produce one report on the expected total cost if current trends continue (i.e., the cost of not purchasing the new software) and another report on the total cost reduction, if any, resulting from the implementation of the proposed software.

Another analysis that can generate prospective information can include forecasting. The system may provide information on potential functionality and performance in the future based on changes to trends identified within behavioral patterns. This information may provide the user with quantifiable data on the impact of the user experience if selected trends were to vary substantially from the current pattern or direction.

In one embodiment, the system can identify an applet whose load time is trending upwards by 20% over the previous month. If the trend continues for the next three months, the applet's load time will increase a total of 80%. Based on the relational data for this component, further analysis may reveal that, based on the number of documents in which the applet is contained, overall application response time will increase by a corresponding 30%. This may violate a defined threshold and trigger an automated alert, notifying the user of a potential performance problem, and the source of the problem, before it occurs. By catching the problem before it occurs, potential revenue loss due to user dissatisfaction with the network site may be avoided.

In other embodiments, the prospective information may be related to scalability estimation. Behavioral data may be used to determine if the infrastructure supporting an application is sufficient to meet current and future demand. In order to produce the desired output, the system may analyze the behavioral patterns of one or more applications to determine the cause, based on similar patterns, of performance degradation either within existing test results or potential future results derived from scenario modeling. The result could then be compared with a solutions database to determine a potential resolution. The user may then determine if increased scalability is necessary to enact the resolution or if another response is more appropriate.

In one embodiment, a form component may be executed three times a day and produce response statistics that are three times longer in the afternoon than they are in the morning or evening. This disparity may be consistent across a sample time of one month. Trend analysis may provide evidence of this pattern; however, the root cause is unknown. Employing comparative logic the system may, upon user request or as an automated process, analyze the change patterns of all other components whose target URL can be the same as the ACTION property of the form. This analysis may reveal that several additional components, executed at similar intervals, all share the same discrepancy, namely, response times in the afternoon are three times higher than at other times of the day. It may also reveal that there are six scheduled transactions that utilize the form component in the afternoon that run at no other time during the day. The aggregated patterns may suggest that the target URL's host is overloaded by the number of simultaneous requests, and a scalability issue (existence of a performance bottleneck) may be isolated to this point. A solution, such as adding more processing capacity or increasing host resources, may be suggested by the system.

Some advantages with the processes are that may be derived from the use of behavioral profiles that take into account component-level information and attendant analysis routines. The behavioral profiles may be used to determine, in advance, what the user experience will be based on a wide range of variables such as new feature introduction, functionality modification or system alterations. Additionally, developers can use the data derived from behavioral profiles to discover how their applications are being used and what improvements to make during the design process or in the future as changes are made to the application. Architects may mine the data to design new features and functionality.

Another advantage can include managing infrastructure enhancements. System operators can predict what effect upgrades or modifications to the underlying infrastructure will have on various applications. Still another advantage can be used to determining impact(s) related to a change. Various groups developing an application can determine precisely the impact proposed changes may have on a system-wide basis. Note that none of the advantages described herein should be considered critical or required by the invention.

While much of the discussion has addressed an application used on a network, the principles taught herein may be applied to other software applications. For example, a computer may have a software program where a complex sorting routine (e.g., for generating reports) is contemplated for use. The profile construction and analysis may show that the computer has insufficient RAM or will need a faster processor to be able to generate the reports in a timely manner. Additionally, a profile for a plurality of applications may be constructed and analyzed to determine the impact of a change in one or more applications on the other applications that are part of the profile.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. A process for generating prospective information regarding an application, the process comprising:
retrieving data regarding historical information for the application; and
generating prospective information regarding the application based at least in part on the historical information.

2. The process of claim 1, further comprising:
identifying components within the application and component relationships, wherein at least some of the components are part, but not all, of a document; and
testing the application to generate the historical information for the components.

3. The process of claim 2, further comprising sorting the historical information by component type.

4. The process of claim 3, wherein the historical information comprises functional and performance data for the components.

5. The process of claim 3, further comprising tracking a change in a pattern for at least one of the components.

6. The process of claim 2, further comprising sorting the historical information by relationship type.

7. The process of claim 6, further comprising tracking a change in a pattern for a relationship between components.

8. The process of claim 2, wherein the historical information includes metadata that describes how object data were collected when used by the application.

9. The process of claim 8, further comprising tracking a change in a pattern for at least part of the metadata.

10. The process of claim 2, wherein generating prospective information is performed using an analysis selected from:
scenario modeling;
predictive analysis;
forecasting;
scalability estimation;
a combination thereof; and
a derivation thereof.

11. The process of claim 1, further comprising constructing a profile of the application by combining pattern data that includes an object pattern and a metadata pattern for a test profile.

12. The process of claim 1, wherein the historical information includes statuses and statistics for components.

13. The process of claim 12, wherein a type of the statistics is selected from component size, load time, and number of errors.

14. The process of claim 1, wherein the historical information includes pass/fail information and alert information for components.

15. The process of claim 1, wherein generating prospective information is performed using an analysis selected from:
scenario modeling;
predictive analysis;
forecasting;
scalability estimation;
a combination thereof; and
a derivation thereof.

16. A data processing system readable medium having first code embodied therein, the code is designed to generate information regarding an application, the code comprising:
an instruction for retrieving data regarding historical information for the application; and
an instruction for generating prospective information regarding the application based at least in part on the historical information.

17. The data processing system readable medium of claim 16, wherein the code further comprises:
an instruction for identifying components within the application and component relationships, wherein at least some of the components are part, but not all, of a document; and
an instruction for testing the application to generate the historical information for the components.

18. The data processing system readable medium of claim 17, wherein the code further comprises an instruction for sorting the historical information by component type.

19. The data processing system readable medium of claim 18, wherein the historical information comprises functional and performance data for the components.

20. The data processing system readable medium of claim 18, wherein the code further comprises an instruction for tracking a change in a pattern for at least one of the components.

21. The data processing system readable medium of claim 17, wherein the code further comprises an instruction for sorting the historical information by relationship type.

22. The data processing system readable medium of claim 21, wherein the code further comprises an instruction for tracking a change in a pattern for a relationship between components.

23. The data processing system readable medium of claim 17, wherein the historical information includes metadata that describes how object data were collected when used by the application.

24. The data processing system readable medium of claim 23, wherein the code further comprises an instruction for tracking a change in a pattern for at least part of the metadata.

25. The data processing system readable medium of claim 17, wherein the instruction for generating prospective information is performed using an analysis selected from:
scenario modeling;
predictive analysis;
forecasting;
scalability estimation;
a combination thereof; and
a derivation thereof.

26. The data processing system readable medium of claim 16, wherein the code further comprises an instruction for constructing a profile of the application by combining pattern data that includes an object pattern and a metadata pattern for a test profile.

27. The data processing system readable medium of claim 16, wherein the historical information includes statuses and statistics for components.

28. The data processing system readable medium of claim 27, wherein a type of the statistics is selected from component size, load time, and number of errors.

29. The data processing system readable medium of claim 16, wherein the historical information includes pass/fail information and alert information for components.

30. The data processing system readable medium of claim 16, wherein the instruction for generating prospective information is performed using an analysis selected from:
scenario modeling;
predictive analysis;
forecasting;
scalability estimation;
a combination thereof; and
a derivation thereof.
